(19) United States
(12) Patent Application Publication
(10) Pub. No.: US 2012/0077149 A1
(43) Pub. Date: Mar. 29, 2012

(54) Dental Implant System

(75) Inventors: Armin Ospelt, Vaduz (LI); Robert Ganley, Williamsville, NY (US); Heinrich Kappert, Vaduz (LI)

(73) Assignee: IVOCLAR VIVADENT AG, Schaan (LI)

(21) Appl. No.: 13/235,594

(22) Filed: Sep. 19, 2011

(30) Foreign Application Priority Data
Sep. 29, 2010 (EP) 10182811.9

(51) Int. Cl. A61C 8/00

(52) U.S. Cl. 433/173

(57) ABSTRACT

The invention relates to a dental implant system comprising a dental implant (28), a dental restoration part (12), a connector (24) with a central through-hole (58) and a circumferential, radially outwardly projecting collar (30) and with a screw (52) passing through the through-hole (58) by means of which at least the connector (24) may be fixedly connected with the dental implant (28), wherein the collar (30) comprises a first stop surface (26) that interacts with the dental implant (28), and a second stop surface (32) that interacts with an abutment (16) or a dental restoration part (12). The color of the collar (30), in particular the color of the connector (24), at least corresponds to a tooth color or a gingival color. The connector (24) at least partially respectively extends into the dental implant (28) and/or into the abutment (16), and substantially consists of the same material as the abutment (16) or consists of zirconium oxide.

### CROSS-REFERENCE TO RELATED APPLICATIONS

This application claims the benefit of European Patent Application No. 10 182 811.9 filed Sep. 29, 2010, which is hereby incorporated by reference in its entirety.

### TECHNICAL FIELD

The invention relates to a dental implant system having a combination of elements more particularly, a combination of a dental implant, a connector and a restoration.

### BACKGROUND OF THE INVENTION

It has been known for a long time that with the aid of dental implant systems, dental restorations may be provided that do not affect or damage neighboring teeth. In this connection, the dental implant system typically comprises a dental implant as a basis therefor. The dental implant is screwed into the jawbone and incidentally offers safe anchorage for the dental implant system.

The dental implant system in addition to the actual dental implant also comprises a dental restoration part for forming the dental restoration, said dental restoration part having a shape that typically corresponds to the one or more neighboring teeth of the patient.

For the anchorage between the dental restoration part and the dental implant it is known to employ one or two molded or shaped parts that provide the connection. The molded or shaped part adjacent to the dental implant is referred to as a connector and for the most part it is connected to the dental implant in a positive or form-locking manner. Either the dental restoration part immediately follows the connector, or a so-called abutment extends between the connector and the dental restoration part. The abutment often comprises a truncated conical or conical structure in order to be able to extensively absorb and distribute the incurred masticatory forces without causing selective stress on the dental restoration part.

For providing the connection between the connector and the dental implant, it has become known to provide a through-hole in the connector and to pass a screw there-through, said screw then being screwed in a corresponding threaded hole for providing a firm fit of the connector at this position.

It has been proposed to also configure the portion of the connector extending into the dental implant with truncated conical shape in order to still further improve the fit of the connector within the dental implant. This solution, however, results in a bad or poor detachability of the connector if it has to be removed as it tends to particularly stick or adhere if the inclination of the cone or conical shape is small.

Dental implant systems basically experience an extended use. The reason for this at least partially lies in the fact that, in particular, younger patients often dislike or reject to damage and remove the natural and healthy tooth structure of neighboring teeth for providing dental prostheses which is necessary for providing a bridge. Especially younger patients thus rather prefer the provision of a dental implant system.

The implementation of dental implant systems of this kind already in middle-aged or even younger-aged persons, however, entails that the demands on durability and both functional and optical compatibility of dental implant systems have steadily increased. On the one hand, this means that in case of a possible color change there is a desire to exchange the dental restoration part if necessary without effecting a new bone injury. On the other hand, increased demands on the time in function of the dental restoration part imply that the load capacity or strength of the entire implant system, especially in the case of intensive alternating loads such as they arise when chewing, must be high.

Dental implant systems, due to the increased spread, are also of more consequence in terms of costs so that there is the desire to enable a manufacture at the lowest possible cost on the one hand, and durability on the other hand, wherein aesthetic aspects may not be ignored nevertheless. US 2004/0076924 A1, which is hereby incorporated by reference, discloses a dental implant system comprising a two-part abutment, in which the lower part practically acts as a connector. This solution enables a torque-proof anchorage due to the form fit or positive locking between the connector and the dental implant. However, especially in the case of an alternating load, the connector is quite heavily loaded so that it may wear out or break. Moreover, the aesthetic appearance or impression in particular with gingival atrophy or periodontal disease is not particularly well.

### SUMMARY

The invention is based on the object of providing a dental implant system that in view of the aesthetic appearance is also improved in the long term without causing particularly high production costs, wherein a secure and durable mounting of the dental restoration part is possible nevertheless.

According to the invention it is particularly favorable that due to the at least partial extension of the connector into the dental implant, the connector itself is protected and thus is loaded to a lesser extent. Due to the screw that is known per se and that extends through the connector, the connector is pressure-loaded. This enables in a surprisingly easy manner to also produce the connector from an aesthetically appealing material from a metal material, a ceramic material, such as zirconium oxide, a composite material or plastic material at least at its outer periphery that is referred to as collar. This solution was banned in the prior art as the heavy load due to the alternating load would have resulted in a brittle fracture of the connector in the state of the art.

The use of zirconium oxide or another ceramic material for abutments is indeed known for a long time. However, this has nothing to do with the material used for the connector since the connector typically is a mere mechanic force-receiving member that serves to support and bear the dental implant system in or at the dental implant, and the abutment when implanted typically already comes to rest above the gingival edge so that at this position aesthetic aspects always play a role, apart from the fact that a metal abutment would ruin the effect of translucency that is usually desired with dental restoration parts due to the transparent or translucent metal.

According to the invention it is particularly favorable that also in case of periodontal disease for example with persons 30 years of age and older, aesthetic disadvantages through the connector are not to be feared. The dental implant is usually completely screwed into the jawbone and as a bone level implant does not extend beyond the jawbone. Following the jawbone, the collar of the connector is inventively provided that preferably has the color of the gingiva or tooth in order not to disturb visually.

Nevertheless, a secure anchorage between the dental implant on the one hand, and the abutment and/or dental restoration part on the other hand, may be ensured in an inventively particularly favorable manner, the more so as the implementation of the connector made from ceramics or a composite is not opposed by the fact that positive locking elements may be provided at the outer circumference of the connector that interact with positive locking elements of the dental implant and ensure a rotationally fixed or torque-proof support.

According to the invention it is particularly favorable if cylindrical sections extend on both sides of the collar of the connector instead of conical sections. Thereby it is excluded that the dental implant gets stuck, so that the releasability or detachability is readily ensured also after years. The conicity may be preferably simulated by forming the upper portion of the connector in a two-stage manner which portion is then formed by two successive cylindrical portions the diameter of which decreases to the top.

It is particularly favorable if the second portion of the connector comprises an outer geometry that deviates from the round shape. Through this, a safe and form-stable mounting of the connector within the dental implant is possible. However, it is also possible to use a round outer geometry in order to thus easier enable minimum adjustments in the direction of rotation, wherein the angular position of the connector and thus the crown, is then determined by the position that is affixed by the screw passing through the connector.

According to an advantageous embodiment it is provided that the connector consists of the same material as the dental restoration part, in particular consists of zirconium oxide, glass ceramics, titanium, a composite or plastic, and in that in particular the connector and the dental restoration part are free of metal and substantially have the same coefficient of thermal expansion.

According to a further advantageous embodiment it is provided that the second portion of the connector comprises an outer symmetry that deviates from a round shape or at least comprises a protrusion or a profiling that prevents the dental restoration part from twisting relative to the connector.

According to a further advantageous embodiment it is provided that the greatest height (H) of the collar that extends parallel to the longitudinal axis of the connector, amounts to 0.3 mm to 10 mm, in particular to 0.5 mm to 4 mm.

According to a further advantageous embodiment it is provided that the outer diameter of the collar is conically shaped in a direction that runs in the same direction as the second portion of the connector.

According to a further advantageous embodiment it is provided that the transition area between the collar and the second portion is square shaped, or at least is formed having a radius of 1 mm to 5 mm and/or at least comprising a conical, circumferential surface.

According to a further advantageous embodiment it is provided that the outer surface of the second portion and/or at least one inner surface of the dental restoration part is provided with a surface profiling or pattern that in particular comprises undercuts.

According to a further advantageous embodiment it is provided that the dental restoration part includes an abutment and/or a crown.

According to a further advantageous embodiment it is provided that the mounting of the connector, or of the connector and the abutment, or of the connector, the abutment and the crown on the dental implant is effected by means of a screw, wherein the head of the screw is supported on the connector or the abutment or the crown.

According to a further advantageous embodiment it is provided that the connector and the abutment and/or the abutment and the crown are connected with one another in a manner known per se by gluing or soldering.

According to a further advantageous embodiment it is provided that the abutment or the crown, or the abutment and the crown comprise a central pass-through recess or through-hole through which a tool for the screw may at least partially pass through.

According to a further advantageous embodiment it is provided that the abutment consists of zirconium oxide, glass ceramics, titanium, a composite or plastic, and in that the second portion of the connector and the crown consist of glass ceramics, zirconium oxide, a composite or plastic.

According to a further advantageous embodiment it is provided that at least the collar of the connector has a thin coating of color or at least partially is dyed through.

According to a further advantageous embodiment it is provided that the outer surface of the collar smoothly merges with the outer contour of the abutment or the crown.

According to a further advantageous embodiment it is provided that the zirconium oxide from which the connector is made, comprises a solubility of about <100 μg/cm² and/or a biaxial bending strength of greater than about 800 MPa and/or a fracture toughness of greater than or equal to about 5 MPa m^{1/2}.

According to a further advantageous embodiment it is provided that the dental implant system comprises a dental implant, a dental restoration part and a connector as well as a circumferential, radially outwardly projecting collar, wherein the color of the collar, in particular the color of the connector, at least corresponds to a tooth color or a gingival color, and wherein at least one portion of the connector following the collar extends into the dental restoration part, and wherein the portion upon manufacture thereof comprises a length that is larger than the smallest height of the dental restoration parts as it occurs in practice, wherein the portion extends into the dental restoration part and wherein the portion may be shortened to the required length if applicable and necessary.

### BRIEF DESCRIPTION OF THE DRAWINGS

Embodiments of the present invention will be more fully understood and appreciated by the following Detailed Description in conjunction with the accompanying drawings, in which:

FIG. 1 is a schematic view of an embodiment of the dental implant system according to the invention prior to its assembly;

FIG. 2 is a further embodiment of an inventive dental implant system;

FIG. 3 is a further embodiment of an inventive dental implant system;

FIG. 4 is a further embodiment of an inventive dental implant system;

FIG. 5 is a further embodiment of an inventive dental implant system;

FIG. 6 is a further embodiment of an inventive dental implant system;

FIG. 7 is a schematic view of a detail of an inventive dental implant system in one embodiment showing the collar of the connector;

FIG. 8 is a modified embodiment of the view according to FIG. 7;

FIG. 9 is a further modified embodiment of the view according to FIG. 7; and

FIG. 10 is a further modified embodiment of the view according to FIG. 7.

### DETAILED DESCRIPTION

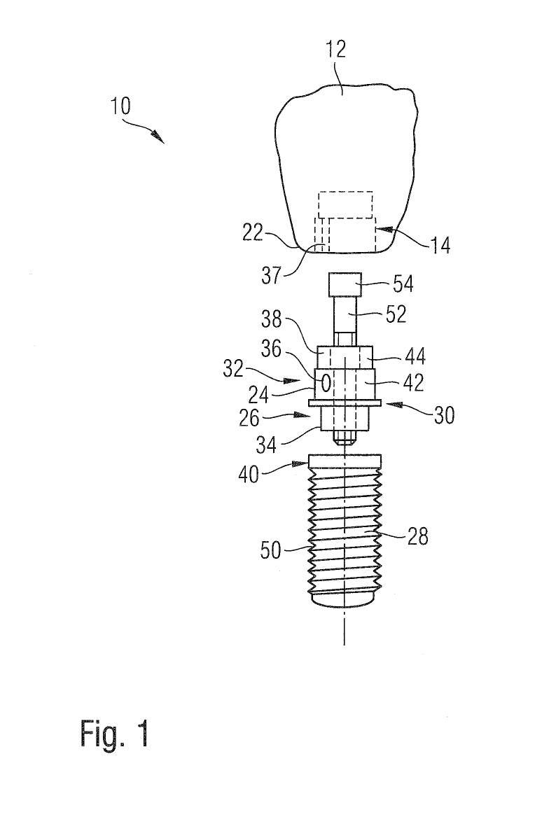

The dental implant system 10 represented in FIG. 1 comprises a dental restoration part 12, as can be seen from the schematic representation. The dental restoration part 12 may for example have the shape of an artificial incisor at its exposed region, as it becomes apparent from FIG. 1. The dental restoration part comprises a recess 14 in a manner known per se.

According to the invention, a connector 24 is provided that comprises a specific shape and a specific structure. The connector 24 is basically divided into three parts. It comprises a first portion 26 that is suitably formed to project into a dental implant 28, a collar 30 and a second section 32. All of the three parts are each cylindrical and according to the invention are accordingly preferably not conical, however, have special features. The connector may consist of zirconium oxide, titanium, glass ceramics, a composite or plastic.

The first section 26 comprises positive locking elements 34 that impart an unround outer shape to the cylinder arranged there. The positive locking elements 34 exactly fit into respective recesses in the dental implant 28. During the insertion of the connector 24 into the dental implant 28, the collar 30 with its lower first connection surface ends up on the top side of the dental implant 28. The outer diameter of the collar 30 corresponds to the outer diameter of the dental implant at its connection 40. Thus a flush transition between the collar 30 and the connection 40 is possible.

The connector 24 at least in the region of the collar 30 or the outer side thereof consists of a material that either has the color of the tooth or the gingiva. It is preferred that the connector 24 in total consists of a ceramic material such as zirconium oxide, however, it is also possible to make it from a composite, plastic or metal, such as titanium, wherein right in the latter case the outer region of the collar 30 is then provided with the tooth color or color of the gingiva.

The second portion 32 of the connector 24 itself is divided into two parts. It comprises a first cylindrical section 42 and a second cylindrical section 44. The first cylindrical section 42 comprises a larger diameter than the second cylindrical section 44. Considering the sequence of diameters of the collar 30, the first cylindrical section 42 and the second cylindrical section 44, a simulated cone arises despite the use of individual cylinders.

In this way, the connector 24 with its first section 26 readily fits into a respective recess 24 in the dental restoration part 12 and lies flush there.

For the fixation of the angular position, two opposing positive locking elements 36 and 37 are provided in the recess 14 and at the second section 32.

The flush arrangement, on the other hand, implies that the diameter of the collar 30 corresponds to the diameter of the lower end 22 of the dental restoration part 12. The diameter of the collar 30 which in the illustrated embodiment of FIG. 1 is designed cylindrically, at the same time corresponds to the upper diameter of the dental implant 28 at the connection 40 thereof.

In a manner known per se, the dental implant 28 comprises a thread 50 at its outer circumference that serves for the anchorage in the jawbone.

For providing the inventive dental implant system 10, first the dental implant 28 with the thread 50 is introduced into the jawbone in a manner known per se, too. This, for example, is effected with the aid of a screw wrench that ends with positive locking elements at the end thereof corresponding to the positive locking elements 34 of the connector 24.

The dental implant 28 comprises an internal thread below these positive locking recesses. The internal thread matches the external thread of a screw 52. The screw 52 is designed so that it passes through a through hole 58 in the connector 24. After the dental implant 28 has been attached, the screw 52 is now inserted through the connector 24. In the exemplary embodiment according to FIG. 1 the screw 52 is screwed into the internal thread of the dental implant 28 so that the screw head 54 of the screw rests on the second portion 32 of the connector 24, if necessary in a recess known per se, and safely holds the connector 24 in the dental implant 28 and in particular in a rotatably fixed manner.

Following to this, the dental restoration part 12, that is to say the corresponding crown in the illustrated exemplary embodiment, with the recess 14 thereof is put on the formed unit consisting of the screw 52 and the connector 24, and is affixed there in a suitable manner, for example by soldering or gluing.

The embodiment according to FIG. 1 provides that the dental implant system or the dental restoration system is implemented without an abutment and that the connector 24 with its second portion 32 immediately enters the recess 14 of the dental restoration part, wherein it is to be understood that the recess 14 must then be formed correspondingly.

According to the invention it is favorable if the connector 24 consists of a translucent material such as zirconium oxide. Surprisingly it is not necessary to use a material such as titanium for the connector, that is probably attributed to the fact that the connector 24 with its first portion 26 is safely accommodated in the dental restoration part 12 that for example may also consist of titanium.

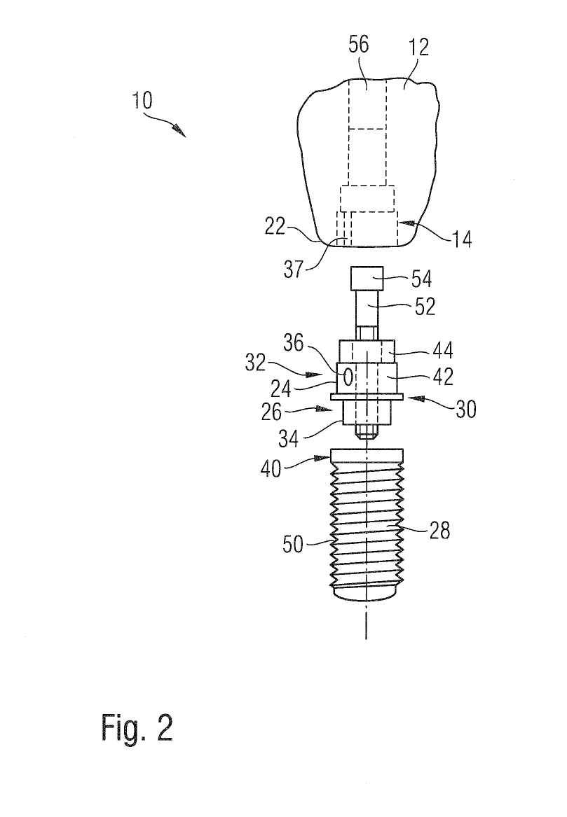

According to FIG. 2 it is provided to implement a dental implant system that also does not comprise an abutment 16. This embodiment differs from the embodiment according to FIG. 1 in the crown 12 having a through-hole 56 that extends between the upper side thereof and the recess 14. The through-hole 56 comprises a diameter that is suitable for accommodating a tool for screwing in or releasing the screw 52, wherein the diameter, however, is not selected to be substantially larger than the respective shank of the tool. After the screw 52 has been tightened, the through-hole 56 is closed in a manner known per se with a suitable filler or sealing compound, wherein it is preferred that the through-hole 56 does not end at a labial, but a lingual side of a front tooth.

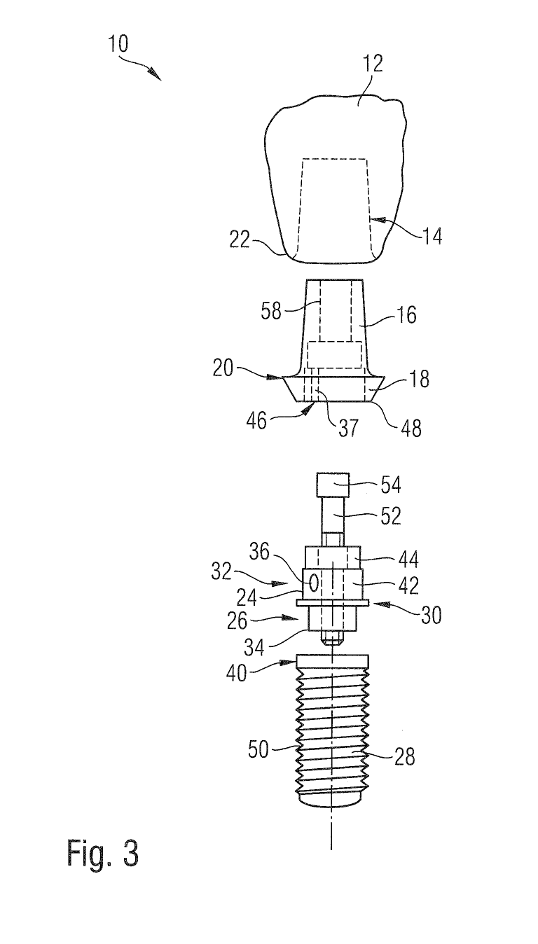

The embodiment according to FIG. 3 differs from the embodiment according to FIG. 1 and FIG. 2 in having an abutment 16. The recess 14 is accordingly configured in a different manner.

The abutment 16 that is configured according to the shape of the recess 14 and which for example runs slightly conically, fits into the recess 14.

In the later finished state, the abutment 16 and the dental restoration part 12 are connected with one another by means of a suitable medium such as dental cement. The abutment 16 as well as the dental restoration part consists of ceramics, however, preferably of a quite solid ceramic material such as zirconium oxide, whereas a lithium disilicate ceramic material may be used for the dental restoration part 12, or for example a plastic material or a composite.

In a manner known per se, the abutment 16 comprises a connection cone 18 at the lower portion thereof. The connection cone 18 has a diameter at the upper end 20 thereof that corresponds to the diameter of the lower end 22 of the dental restoration part 12 so that a flush transition is given at this position.

Even if the remaining wall thickness of the abutment 16 surrounding the recess 46 is represented to be quite small, it is to be understood that in practice said wall thickness may be adapted to the requirements in broad areas in order to ensure the desired strength and safety.

A through hole or recess 58 is provided in the abutment 16 for accommodating the screw 52. In the embodiment according to FIG. 3, the through-hole 58 is designed somewhat larger than the screw head 54 so that the screw 52 may be freely passed through the abutment 16. For assembly, the connector 24 is inserted into the recess 46 of the abutment 16 and the unit consisting of the screw 52 and the connector 24 is attached to the dental implant 28 with the aid of the screw 52. According to the invention it is favorable that said connection may be undone by unscrewing the screw 52 if desired. Following to this, the dental restoration part 12 is attached to the abutment 16 in a manner known per se. It is preferred that the abutment 16 has been previously glued to the projecting unit.

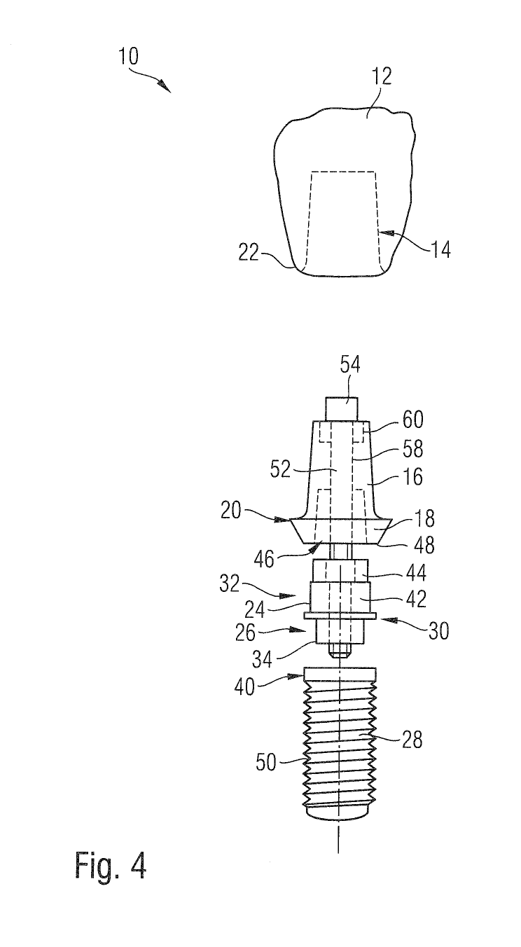

In the embodiment according to FIG. 4 it is provided that the abutment 16 comprises a through hole 58, the diameter of which is somewhat larger than the shank of the screw 52, however, smaller than the diameter of the screw head 54. In this embodiment, the screw 52 thus also holds the abutment 16 so that a pre-assembled solid unit consisting of the dental implant 28, the connector 24, the abutment 16 and the screw 52 is the result, on which the crown may then be affixed.

For accommodating the screw head 54, following to the through hole 58 a somewhat enlarged recess 60 is provided in the top end of the abutment 16 so that the screw head 54 may be accommodated in the abutment 16 in a recessed manner.

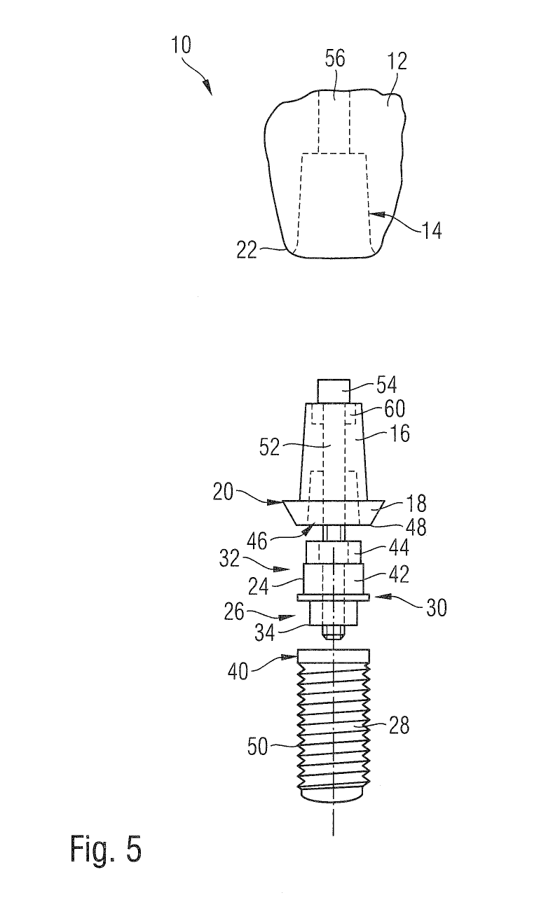

The embodiment according to FIG. 5 basically represents a combination of the embodiments according to FIG. 2 and FIG. 4. In contrast to the embodiment according to FIG. 4 a through-hole 56 is provided here that passes through the crown 12 and enables the insertion of a tool for the screw head 54.

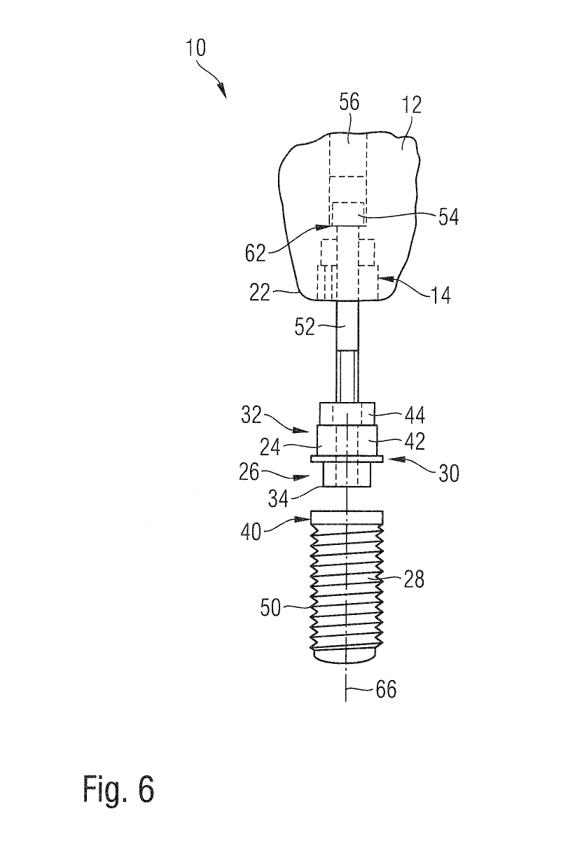

FIG. 6 shows a further modified embodiment. In this embodiment no abutment 16 is provided, in fact the connector 24 is immediately accommodated within the recess 14 of the crown 12. The crown 12 comprises a through-hole 56 that accommodates the screw head 54 in its upper part. Distinctly above the recess 14, however, the through-hole 56 has a reduced diameter so that the diameter is smaller there than the diameter of the screw head 54, however, is larger than the diameter of the shank of the screw 52. Because of this, the screw head 54 rests on an abutment or stop surface 62 within the crown 12 so that the unit consisting of the crown or dental restoration part 12, the screw 52, the connector 24 and the dental implant 28 is screwed together by tightening the screw 52. It is to be understood that the abutment or stop surface 62 may also be selected to be notedly larger as shown in FIG. 6 and that also notedly more material for the support of the screw head 54 may be provided in the crown 12.

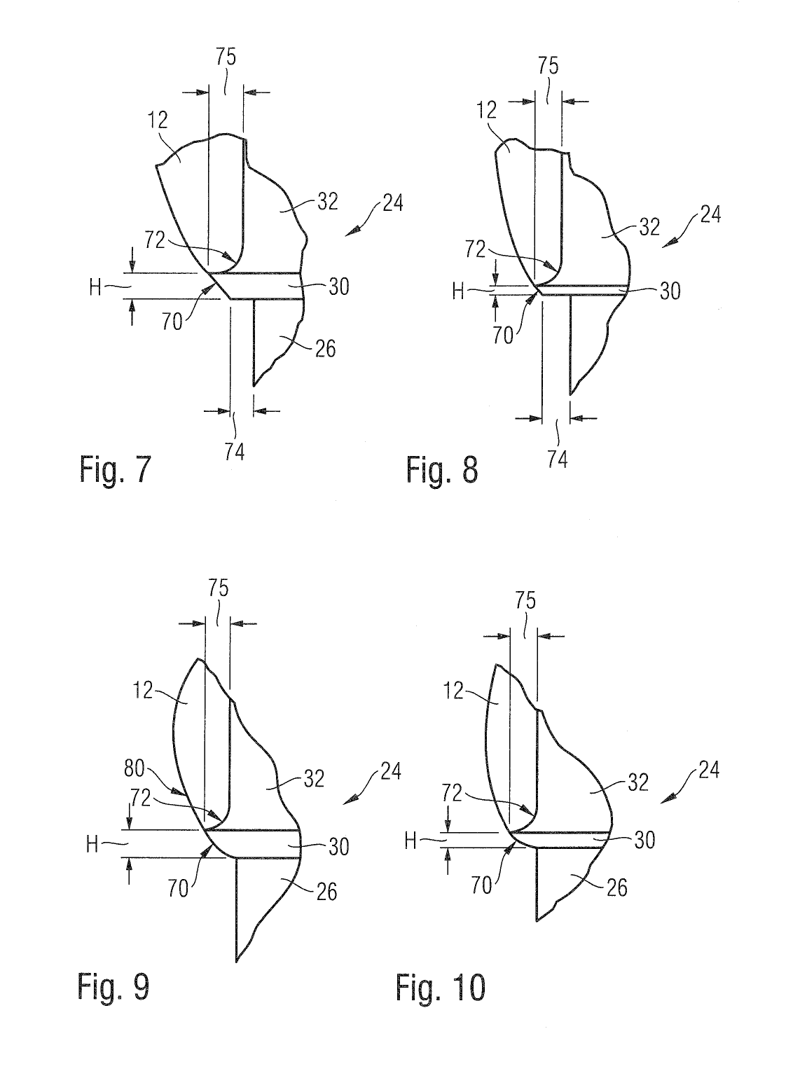

In the embodiments according to FIGS. 1 to 6, the collar 30 of the connector 24 is formed in flat-cylindrical manner according to the invention, that is to say it has an outer surface that extends parallel to an axis 66 of the dental implant system 10. It is to be understood that according to the invention a flush transition of the collar 30, in particular with respect to the abutment 16 or to the crown 12 is desired, and in particular with respect to the dental implant 28. In the FIGS. 7 to 10 suitable configurations of the outer circumference of the collar 30 are represented. In the embodiment according to FIG. 7 the collar 30 is designed in a conical manner with respect to its outer surface. The connector 24 has a larger outer diameter at its first portion 26 compared to its second portion 32; compared to both portions, however, the collar 30 projects significantly. The projection extents or degrees 74 and 75 in this embodiment, however, are approximately equal as the cone angle of the outer surface 70 is selected to be quite large and amounts to approximately 45 degrees, and as the height H of the collar 30 approximately corresponds to the projection degree or extent. Preferably, it corresponds to a tenth up to a third of the diameter of the collar 30.

FIG. 7 represents the accommodation of the first part 26 in a crown 12. It is to be understood that in a similar manner also the accommodation in an abutment 16 having a connection cone 18 may be provided, as it is represented in FIG. 3, FIG. 4 and FIG. 5.

According to the invention it is particularly favorable if the transition between the first portion 26 and the collar 30 is curved or smoothed out. According to FIG. 7, a curve or fillet 72 with a radius is provided at this position, said radius approximately corresponding to the projection degree or extent 74.

According to FIG. 8 a further embodiment of the connector 24 is represented. In this embodiment, the collar 30 comprises a notedly smaller height H compared to the embodiment according to FIG. 7. The height amounts to approximately one third of that of FIG. 7 and thus also one third of the size of the projection extent 74.

A further embodiment of a connector 24 is represented in FIG. 9. In this embodiment, the collar 30 at its outer surface 70 is designed to be spherical or convex, basically in an extension of the convexity 80 of the crown 12 at its outer side. The collar 30 also here merges with the first portion 26 by means of a fillet 72. Due to the convexity, the collar at the lower end thereof practically merges with the second portion 32 without transition. The outer surface 70 of the collar 30 in this embodiment is even more strongly inclined than in the embodiments according to FIG. 7 and FIG. 8; the average angle of inclination with respect to the axis 66 (please compare FIG. 6) amounts to approximately 60 degrees.

A still larger inclination of the outer surface 70 of the collar 30 of the connector 24 becomes apparent from FIG. 10. In this embodiment also the height H of the collar 30 is smaller, approximately half the size of height H of the collar in the embodiments according to FIG. 7 and FIG. 9. This causes a still steeper angle of inclination of the outer surface 70 with respect to the axis 66 according to FIG. 6, which in the illustrated embodiment amounts to approximately 70 degrees.

In a modified embodiment of the invention it is provided to optimize the structure of the second portion 32. In a primary embodiment, the second part 32 of the connector 24 thus at least partially extends in a conically tapering manner. Alternatively, it is tapered in a stepped manner. In a further particularly preferred embodiment the second portion 32 is clearly extended compared to the representation in the figures. It extends with a height that at least corresponds to 0.4 times the dental restoration part 12, or with an even larger height than the dental restoration part 12. With this solution, the portion 32 may then be shortened as required before the dental restoration part 12 is attached. This embodiment also offers the advantage of considerably reducing the costs of storage. The connector 24 merely needs to be held available in one single height, even if tooth heights of completely different provenance are to be covered.

In order to impart a particularly good support to the entire dental restoration it is also conceivable that the second portion passes through the dental restoration part in the area of the chewing or occlusal surface. After the dental restoration part 12 has been attached, as the case may be with the abutment 16, the second portion is then shortened to the required length and closed and forms part of the chewing or occlusal surface.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A dental implant system comprising;
a dental implant,
a dental restoration part,
a connector with a central through-hole or passage and with a circumferential, radially outwardly projecting collar and with a screw passing through the passage with the aid of which at least the connector may be fixedly connected to the dental implant,
wherein at least a color of the collar, at least corresponds to a tooth color or a gingival color, and
wherein a first portion of the connector that extends from the collar, extends into the dental implant, and a second portion of the connector that extends from the collar, extends into the dental restoration part.

2. The dental implant system of claim 1, wherein a color of the connector, at least corresponds to a tooth color or a gingival color.

3. The dental implant system as claimed in claim 1, wherein the connector is fabricated of the same material as the dental restoration part.

4. The dental implant system of claim 1, wherein the wherein the connector and the dental restoration part are fabricated of zirconium oxide, glass ceramics, titanium, a composite or plastic.

5. The dental implant system of claim 4 wherein the connector and the dental restoration part are free of metal and have substantially the same coefficient of thermal expansion.

6. The dental implant system as claimed in claim 1, wherein the second portion of the connector comprises an outer symmetry that deviates from a round shape or at least comprises a protrusion or a profiling that prevents the dental restoration part from twisting relative to the connector.

7. The dental implant system as claimed in claim 1, wherein the collar comprises a greatest height (H) that extends parallel to the longitudinal axis of the connector, of up to about 0.3 mm to about 10 mm.

8. The dental implant system as claimed in claim 7, wherein the greatest height (H) is from about 0.5 mm to about 4 mm.

9. The dental implant system as claimed in claim 1, wherein an outer diameter of the collar is conically shaped in a direction that runs in the same direction as the second portion of the connector.

10. The dental implant system as claimed in claim 1, wherein a transition area between the collar and the second portion is square shaped, or at least is formed having a radius of about 1 mm to about 5 mm and/or at least comprising a conical, circumferential surface.

11. The dental implant system as claimed in claim 1, wherein an outer surface of the second portion and/or at least one inner surface of the dental restoration part is provided with a surface profiling or pattern that comprises undercuts.

12. The dental implant system as claimed in claim 1, wherein the dental restoration part comprises an abutment and/or a crown.

13. The dental implant system as claimed in claim 1, wherein the mounting of the connector, or of the connector and the abutment, or of the connector, the abutment and the crown, on the dental implant comprises a screw, wherein the head of the screw is supported on the connector or the abutment or the crown.

14. The dental implant system as claimed in claim 1, wherein the connector and the abutment and/or the abutment and the crown are connected with one another by gluing or soldering.

15. The dental implant system as claimed in claim 1, wherein the abutment or the crown, or the abutment and the crown comprise a central pass-through recess or through-hole through which a tool for the screw may at least partially pass through.

16. The dental implant system as claimed in claim 1, wherein the abutment comprises zirconium oxide, glass ceramics, titanium, a composite or plastic, and wherein the second portion of the connector and the crown comprises glass ceramics, zirconium oxide, a composite or plastic.

17. The dental implant system as claimed in claim 1, wherein at least the collar of the connector has a thin coating of color or at least partially is dyed therethrough.

18. The dental implant system as claimed in claim 1, wherein an outer surface of the collar smoothly merges with the outer contour of the abutment or the crown.

19. The dental implant system as claimed in claim 4, wherein the zirconium oxide from which the connector is made, comprises a solubility of <100 μg/cm2 and/or a biaxial bending strength of >800 MPa and/or a fracture toughness of greater than or equal to about 5 MPa m^{1/2}.

20. A dental implant system comprising
a dental implant,
a dental restoration part, and
a connector comprising a circumferential, radially outwardly projecting collar,
wherein a color of the collar, at least corresponds to a tooth color or a gingival color, and
wherein at least one portion of the connector that extends from the collar extends into the dental restoration part, and
wherein the portion upon manufacture thereof comprises a length that is larger than the smallest height of the dental restoration part,
wherein the portion extends into the dental restoration part and wherein the portion may be shortened to the required length if applicable and necessary.

21. The dental implant system as claimed in claim 20, wherein a color of the connector, at least corresponds to a tooth color or a gingival color.
